(19) United States
(12) Patent Application Publication
(10) Pub. No.: US 2026/0133852 A1
(43) Pub. Date: May 14, 2026

(54) ADAPTIVE INLINE CODEBOOK COMPRESSION

(71) Applicant: Intel Corporation, Santa Clara, CA (US)

(72) Inventors: Duane E. GALBI, Wayland, MA (US); Ellick CHAN, Portland, OR (US); Susanne M. BALLE, Hudson, NH (US)

(21) Appl. No.: 19/427,704

(22) Filed: Dec. 19, 2025

(51) Int. Cl. G06F 9/50

(52) U.S. Cl. CPC G06F 9/5088; G06F 9/5016; G06F 9/5027; G06F 2209/509

(57) ABSTRACT

Examples described herein relate to an interface and a processor, coupled to the interface, that is configured to: offload decompression of codebook compressed data to a device, wherein the data comprises weight data, wherein the codebook compressed data comprises data represented by code values, and wherein the code values utilize less memory than the corresponding data. In some examples, the device comprises a direct memory access (DMA) engine. In some examples, the device comprises an accelerator to perform matrix multiplication or a decoder.

### BACKGROUND

Codebook encoding maps input data to a nearest value in a predefined codebook using clustering algorithms and storing an index of the codebook entry instead of the data, to reduce the size of stored information. Codebook compression maps compressed codes to high precision data elements associated with index values in a lookup table. Codebook decoding uses a fixed, one-to-one mapping of index values to data values. Codebook values can be further compressed through the use of variable length codes and other compression schemes.

### BRIEF DESCRIPTION OF THE DRAWINGS

FIG. 1 depicts an example system.

FIG. 2 depicts an example of operations.

FIG. 3 depicts an example of operations.

FIG. 4 depicts an example of operations.

FIG. 5 depicts an example system.

FIG. 6 depicts an example weight decompression.

FIGS. 7A and 7B depict example codebook de-compression using an outlier matrix.

FIG. 8 depicts an example of compression of a codebook and an outlier matrix using variable length coding (VLC).

FIG. 9 depicts an example of storing codes and outlier values.

FIG. 10 depicts an example process.

FIG. 11 depicts an example system.

### DETAILED DESCRIPTION

Various examples can perform in-line decompression of codebook encoded data via a circuitry in a Direct Memory Access (DMA) circuitry or systolic array matrix multiply accelerator. Various examples can improve throughput of decompressing data and reduce power consumption from decompressing data.

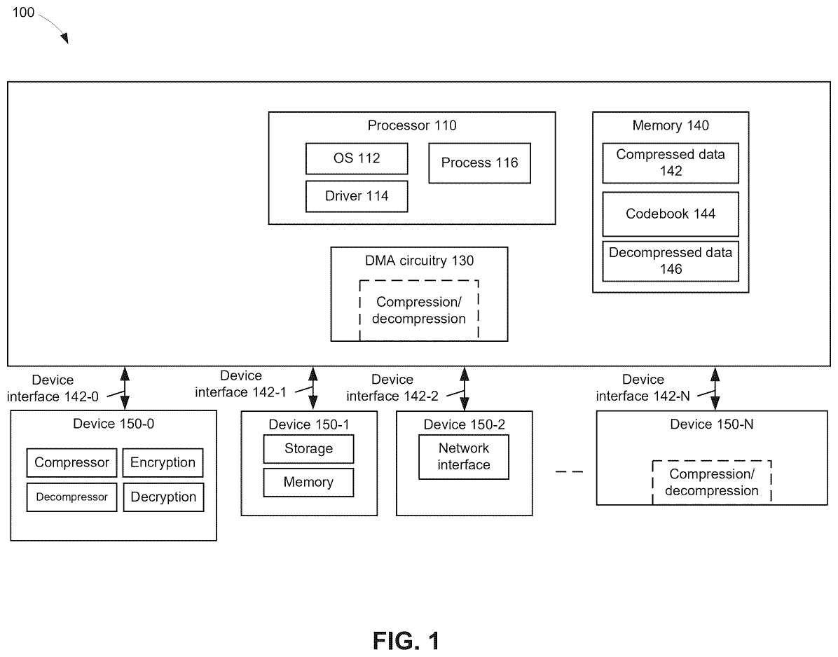

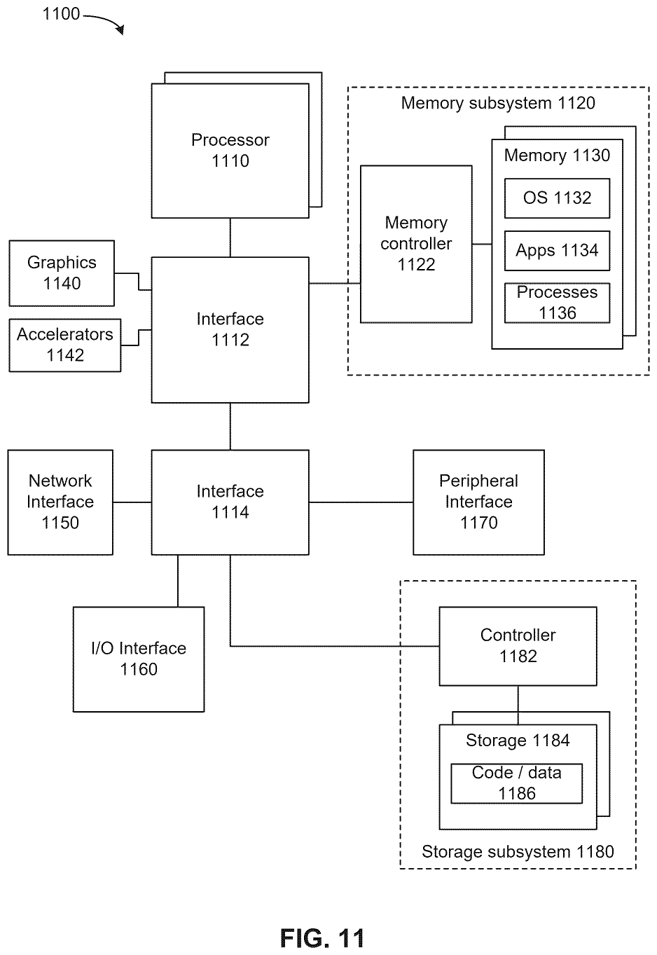

FIG. 1 depicts an example system. System 100 can include processor 110, memory 140, one or more of devices 150-0 to 150-N, where N is an integer, and other circuitry and software described at least with respect to FIG. 11. Processor 110 can include one or more general purpose processors, including at least: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix multiplication (MU), or other circuitry. A processor core can include an execution core or computational engine that is capable of executing instructions. A core can access to its own cache and read only memory (ROM), or multiple cores can share a cache or ROM. Accelerator cores, slices, and/or cores can be homogeneous (e.g., same processing capabilities) and/or heterogeneous devices (e.g., different processing capabilities). A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processor 110 can execute processes 116 that can request packet processing, packet transmission, copying of received packets, data compression, data decompression, data encryption, data decryption, data copying, or other operations to be performed by one or more of devices 150-0 to 150-N. Processes 116 can include one or more of: an application, process, thread, a virtual machine (VM), microVM, container, microservice, virtual function (VF), virtual device, or other virtualized execution environment.

One or more of devices 150-0 to 150-N can perform operations offloaded from processor 110. Devices 150-0 to 150-N can include one or more of: an accelerator, a memory device, a memory controller, a decoder, a storage device, a storage controller, a network interface device, or other circuitry, such as circuitry described with respect to FIG. 11. For example, an accelerator can perform cryptographic, compression, or decompression operations on weight data or matrix multiplication on decompressed data. A network interface device can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

Processor 110 can access one or more of devices 150-0 to 150-N by die-to-die communications; chipset-to-chipset communications; circuit board-to-circuit board communications; package-to-package communications; and/or server-to-server communications. Die-to-die communications can utilize Embedded Multi-Die Interconnect Bridge (EMIB) or an interposer. Components of FIG. 1 (e.g., processor 110, memory 140, devices 150-0 to 150-N, or others) can be enclosed in one or more semiconductor packages. A semiconductor package can include metal, plastic, glass, and/or ceramic casing that encompass and provide communications within or among one or more semiconductor devices or integrated circuits.

Processor 110 can access one or more of devices 150-0 to 150-N using device interfaces 142-0 to 142-N consistent at least with Peripheral Component Interconnect express (PCIe), Compute Express Link (CXL), or other standards. The PCIe protocol is described in Peripheral Component Interconnect (PCI) Express Base Specification 1.0 (2002), as well as earlier versions, later versions, and variations thereof. The CXL protocol is described in Compute Express Link Specification version 1.0 (2019), as well as earlier versions, later versions, and variations thereof). Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

Direct memory access (DMA) circuitry 130 can include a hardware component that transfers data between memory and peripherals as offloaded from processor 110, allowing processor 110 to perform other tasks and improve system performance and speed. DMA engine circuitry 130 manages the memory addresses and an amount of data for data transfers.

Memory 140 can store compressed data 142 that includes packed/compressed weight values in place of data. In some examples, as described herein, data 142 can include codes and an outlier matrix. Memory 140 can store codebook 144, that is utilized to compress or decompress data. In some examples, where data 142 includes a particular code indicating an outlier value and an offset, decompression of data can correct for lossy compression by adding a correction factor to produce decompressed data. Memory 140 can store decompressed data 146 after decompression or before such data is compressed.

Data 142 can include weight data, such as artificial intelligence (AI) weight data, large language model (LLM) key value (KV) cache data (e.g., generated matrix coefficients), LLM weight data (e.g., static matrix coefficients), LLM weight data (static matrix coefficients) with variable length coded (VLC) data, or others.

To initiate decompression of data, processor 110 can issue a descriptor that indicates which device is to compress or decompress data 142 based on a codebook 144, such as, DMA circuitry engine 130, device 150-N, or processor 110. In addition, the descriptor can identify a starting memory address of compressed data 142, length of data 142, a starting memory address of compressed codebook 144, as well as starting memory address of decompressed data 146.

In some examples, device 150-N that performs decompression based on codebook 144 can include a matrix multiplication unit (MU) or a data decoder. An MU can include a hardware component that performs the computationally intensive operation of matrix multiplication efficiently by leveraging parallel processing. For example, when a copy is initiated, a tensor descriptor is provided which includes information such as the size of a tensor (e.g., data 142), stride (e.g., distances between consecutive points along the same dimension), data type format, and a lookup table (e.g., codebook 144). DMA engine 130 can access memory 140 and performs in-line translation using the LUT, and perform conversion of codes to decompressed data (e.g., data 146). Codebook decompression can utilize a fixed size input and fixed size output (e.g., 4 bit input and 16 bit output, or other sizes).

Matrix multiplication operations can be performed at least for deep learning, computer graphics, and simulations.

An example of operations to perform data decompression based on a codebook can be as follows. First, DMA circuitry 130 or device 150-N can load a codebook 144 (e.g., packed or unpacked). For example, processor 110 can execute an Advanced Matrix Extensions (AMX) tile load to load the decompressed data. Second, DMA circuitry 130 or device 150-N can use codebook 144 to decompress weights in data 142. Third, DMA circuitry 130 or device 150-N can output decompressed weights and store the decompressed weights as decompressed data 146. Fourth, processor 110 or an MU can use decompressed weights as input operands to perform matrix operations such as matrix multiplication, or others.

Components of FIG. 1 (e.g., processor 110, memory 140, devices 150-0 to 150-N, or others) can be enclosed in one or more semiconductor packages. A semiconductor package can include metal, plastic, glass, and/or ceramic casing that encompass and provide communications within or among one or more semiconductor devices or integrated circuits. In some examples, system 100 can be implemented in a semiconductor package. The semiconductor package can include metal, plastic, glass, and/or ceramic casing that covers and encapsulates one or more semiconductor devices or integrated circuits (e.g., processor 110, memory 140, or one or more of devices 150-0 to 150-N) and provides communications within or among the one or more semiconductor devices or integrated circuits.

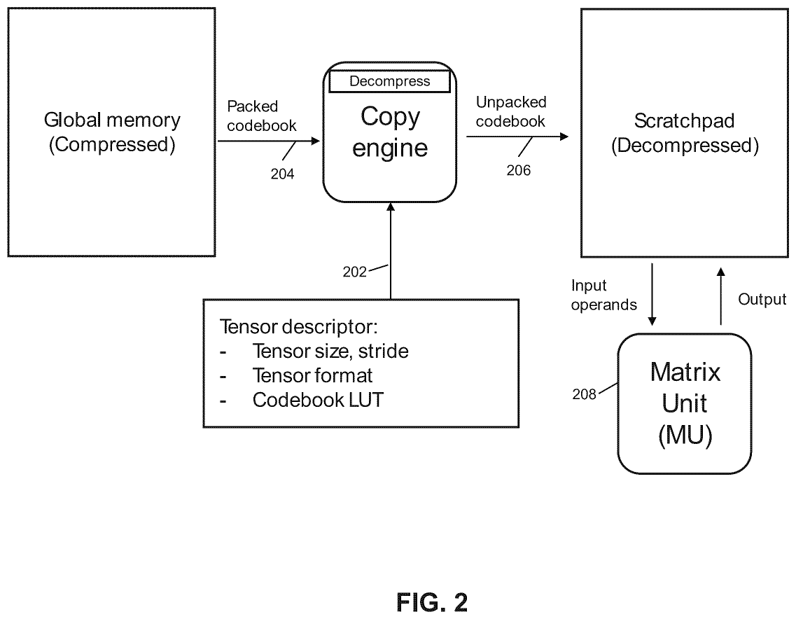

FIG. 2 depicts an example of operations. At 202, copy engine (e.g., DMA engine) can receive a descriptor that specifies a starting address of data (e.g., tensor and size and stride, tensor format, and memory address of memory of a codebook look up table (LUT). At 204, copy engine can access the codebook and decompress the data. At 206, the copy engine can store the decompressed data into a scratchpad accessible to a processor or MU accelerator. For example, the scratchpad can include a register or cache of a processor core or MU accelerator. At 208, the processor or MU accelerator can perform operations to process the decompressed data. Operations can include matrix multiplication (e.g., each element in the resulting matrix is found by taking the dot product of a row from a first matrix and a column from a second matrix), or other arithmetic operations (e.g., summation, subtraction, min, max, or others).

In some examples, compressed weight data in memory 300 and decompressed weight data in scratch pad (e.g., on chip cache) may be non-coherent and different from the value stored in memory 300 because the data was compressed or decompressed.

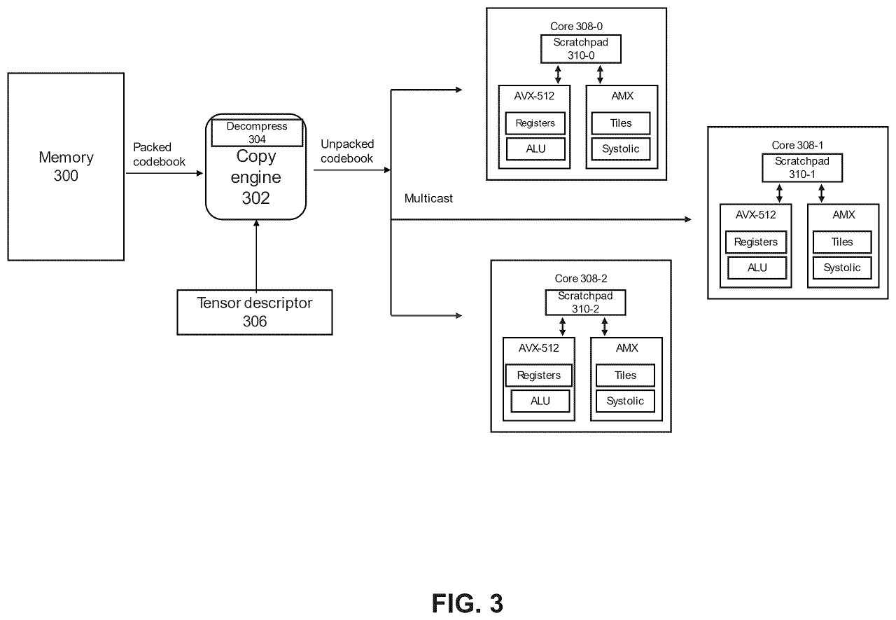

FIG. 3 depicts an example of operations. In some examples, DMA engine 302 can store decompressed data into scratchpads associated with one or more cores 306-0 to 306-2 or accelerators. Scratchpads for one or more cores 306-0 to 306-2 can include scratchpad registers accessible to Advanced Matrix Extensions (AMX) instructions. Tensor descriptor 306 can specify tensor size, stride length, tensor format, codebook look up table (LUT), or other parameters of data to codebook decompress. For example, based on a tensor descriptor 306, DMA engine 302 can perform decompression 304 of data using a codebook from memory 302 to generate weights and multicast the weights into a register set. Decompressed data can be written to a scratchpad or tile register where an accelerator can process the data to perform a matrix multiply operation. One or more cores 306-0 to 306-2 can process decompressed data from respective scratch pad memories 310-0 to 310-2. While three cores are depicted, any number of cores can be utilized.

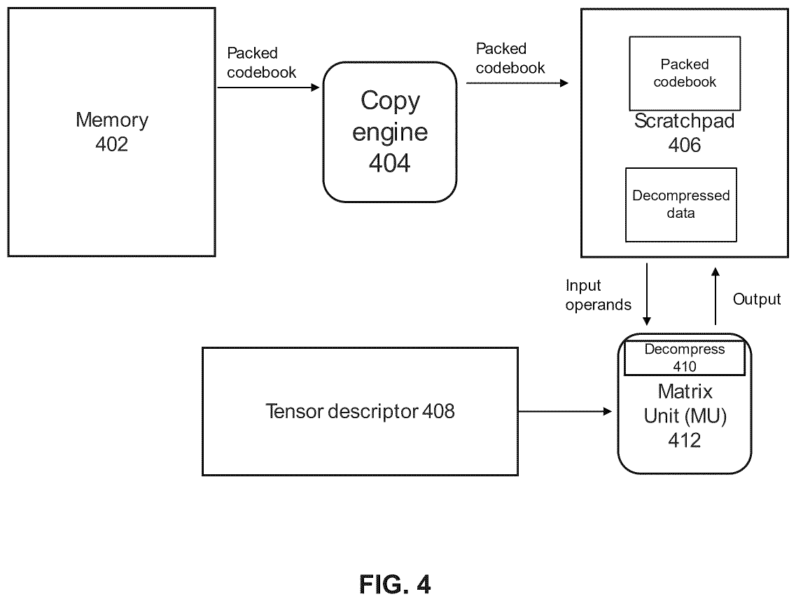

FIG. 4 depicts an example of operations. In some examples, matrix multiply unit 412 performs codebook decompression 410 based on parameters in tensor descriptor 408. Tensor descriptor 408 can specify tensor size, stride length, tensor format, codebook look up table (LUT), or other parameters of data to codebook decompress. A processor can provide descriptor 408 to matrix unit (MU) 412 to specify LUT information in addition to existing tensor size, stride and format entries. MU 412 can perform in-line LUT lookup to generate uncompressed weight data from memory 412. Decompressing data in a computation unit where scratchpad 406 or tile register could store compressed values can allow for processing of larger weight matrices that would not fit in the scratchpad or tile registers in uncompressed format. The added effective size of the scratch pad/tile registers can enable buffering of matrix operations where operands are being read-in from memory while existing operands are being multiplied, or extra space to be used for other operations.

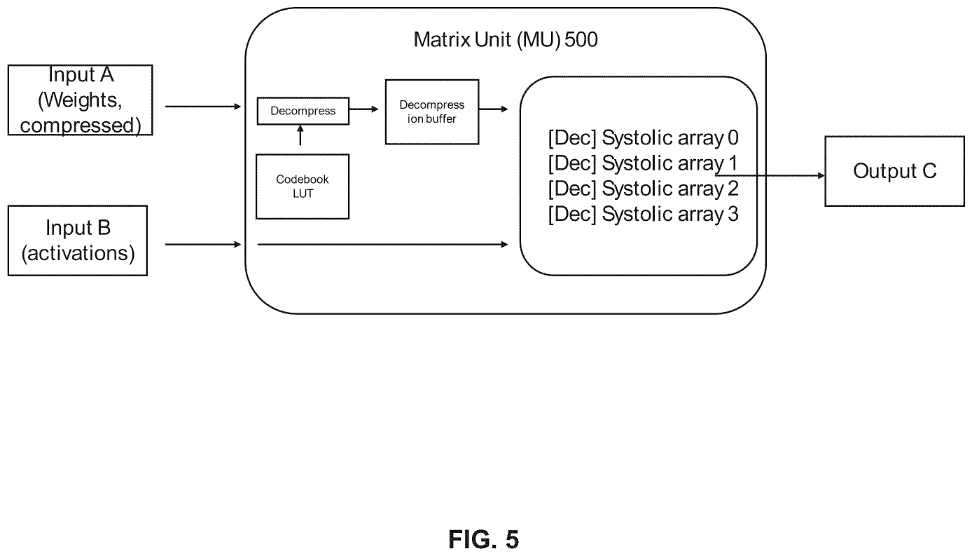

FIG. 5 depicts an example system. Matrix multiply unit 500 may include internal decompression buffer or scratch-pad, which could reduce LUT lookup overhead by reusing translated values. As matrix multiply algorithms reuse input operands, the number of translations can be reduced, throughput can be improved, and energy consumption reduced. The sharing of the decompression buffer could also be across cores in different tiles or dies.

Vector execution units can perform table lookup operations to decompress the data, and format conversion may occur via native upconvert or downconvert instructions or via shifting and masking operations. After the weight matrix has been decompressed, the matrix unit can process this data in decompressed form to perform the matrix multiply. The multiplier may utilize multiple systolic arrays to process decompressed weights of input A. The decompression buffer could store the translated values and multiple core systolic array instances could read from this decompression buffer. Vector units can perform operations such as e\hat{ }x, activation functions such as sigmoid, normalization, tanh, softmax, or others.

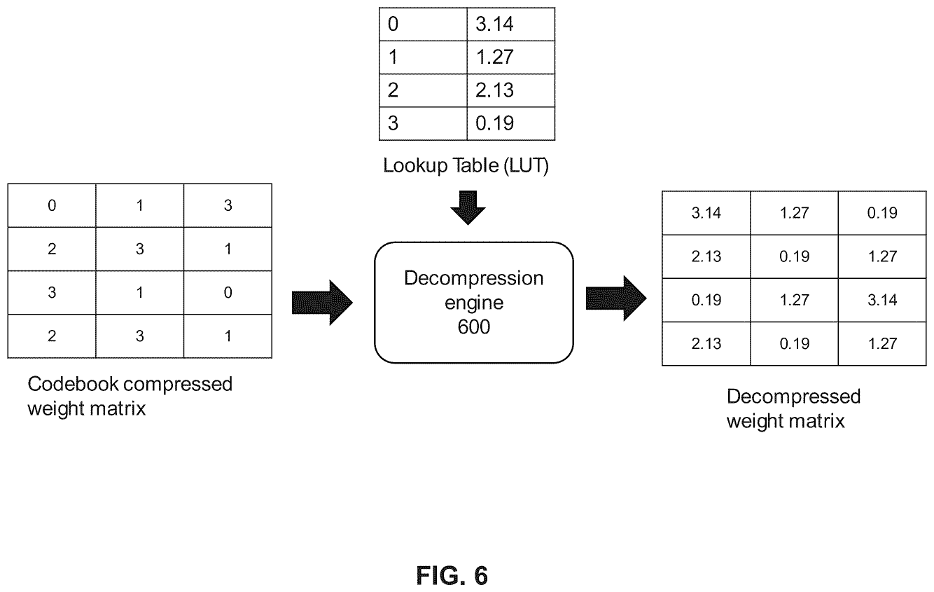

FIG. 6 depicts an example weight decompression. A DMA engine or MU can perform decompression 600 of a weight matrix compressed using a codebook. A codebook or look up table (LUT) for a compressed weight matrix can be input to a copy engine or decompression engine, which can convert the codebook values into decompressed weight values.

For example, outliers can be determined depending on the distribution of the data, where the top and bottom 1%, 3%, 5%, or other values of errors can be considered outliers. In this example, the reference matrix has extreme values: 10.9 and −9.5. Based on codebook compression, the 10.9 can be mapped to the largest possible value, 4.1 (code 5) and the −9.5 can be mapped to the smallest value −5.1 (code 6).

In some cases, a codebook can compress values in a lossy manner so that there is an error between decompressed values and the original values. Where the error between decompressed values and the original values exceed a configured percentage, outliers can be identified. For example outliers can be determined depending on the distribution of the data.

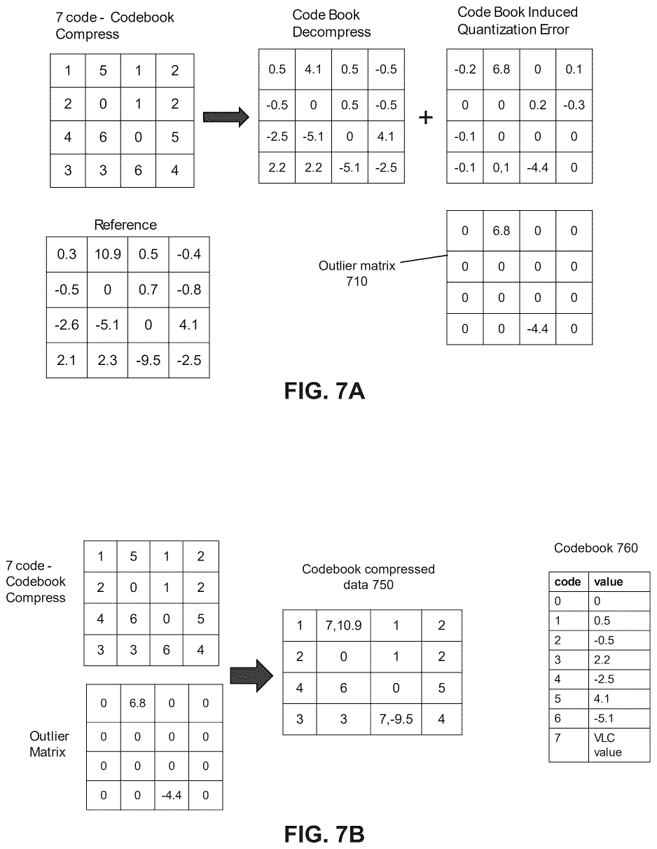

FIG. 7A depicts an example codebook de-compression using an outlier matrix. According to some examples, outlier matrix 710 can store the code and the delta from the value corresponding to the code. Based on codebook compression, the 10.9 can be mapped to the largest possible value, 4.1 (code 5) and the −9.5 can be mapped to the smallest value of −5.1 (code 6) and outlier matrix 710 can be generated by a compressor. Outlier matrix 710 can include a sparse matrix of zero values and values 6.8 and −4.4 to add to respective decompressed values 4.1 and −5.1 to compress values 6.8 and −4.4 to respective 10.9 and −9.5. To decode the value 10.9, value 4.1 (decoded from code 5) can be added to 6.8 (outlier correction). Similarly, −9.5 can be represented as code 6 and value −4.4. To decode the value −9.5, the value −5.1 (decoded from code 6) can be added to −4.4 (outlier correction). In this example, the reference matrix has extreme values: 10.9 and −9.5.

FIG. 7B depicts an example codebook de-compression using variable length coding. In some examples, when a value is represented by a codebook value, the difference between the value and the value represented by the codebook value produces an error. For errors between decompressed values and original values that outliers, the value can be encoded as a code and added error. Codebook compressed data 750 can represent 10.9 and 7, 10.9 and represent −9.5 as 7, −9.5. For example, for outlier values, value 7 followed by an actual decompressed value can be identified in codebook 760.

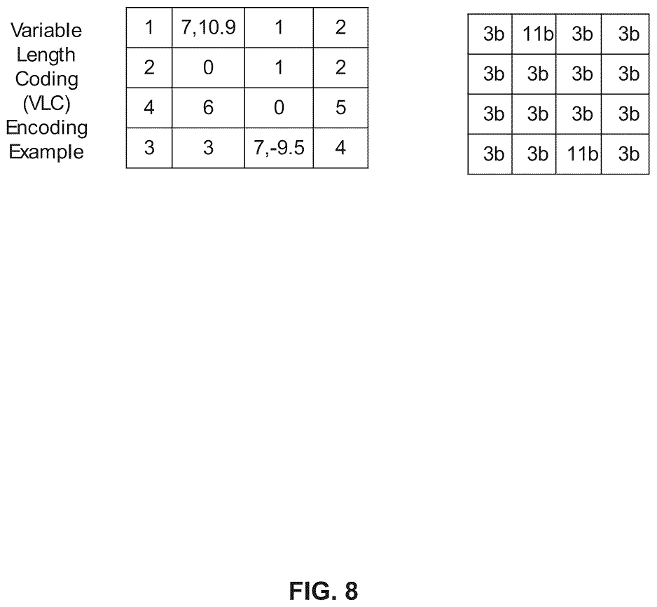

FIG. 8 depicts an example of compression of a codebook and an outlier matrix using variable length coding (VLC). VLC can be used to represent a code and added error. In this example, 3 bits (3 b) can be used to represent a value whereas 11 bits (11 b) can be used to represent a code and the value. For example, code 7 can represent an outlier value and can be associated with value 10.9 or value of −9.5.

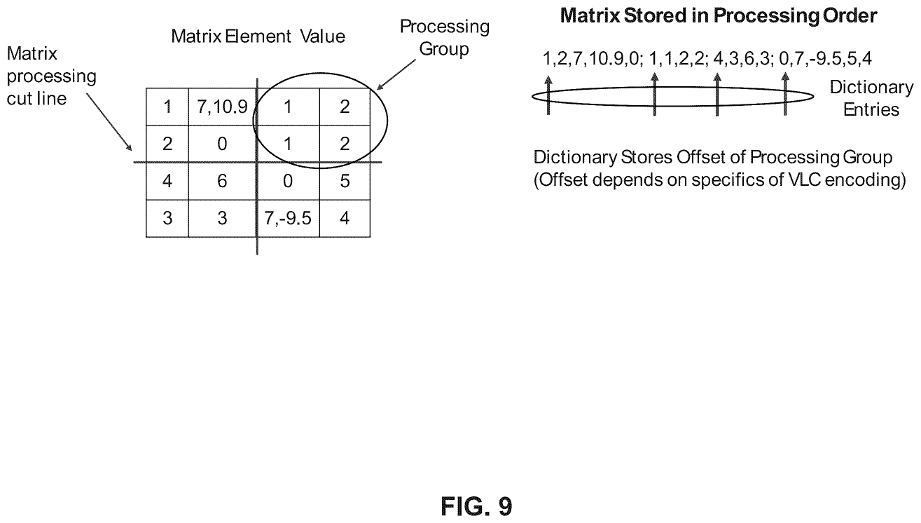

FIG. 9 depicts an example of storing codes and outlier values. In some examples, after compression of data using a codebook, a storage order of dictionary entry values in memory can in order of processing. For example, a matrix can be stored as processing groups of 2×2 elements comprising first through fourth groups. A first group can include 1, 2, 7/10.9, and 0. A second group can include 1, 1, 2, and 2. A third group can include 4, 3, 6, and 3. A fourth group can include 0, 7/−9.5, 5, and 4. Reading elements in a matrix sequentially allows for reading a variable length code as a length of the variable length code can vary but a beginning and end of the variable length code can be determined.

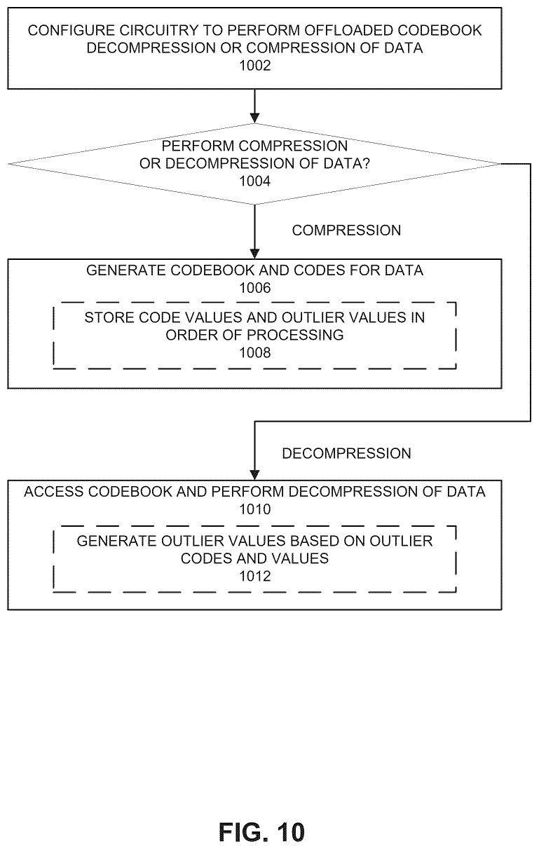

FIG. 10 depicts an example process. At 1002, a circuitry can be configured to perform offloaded compression and/or decompression of data using a codebook. In some examples, the circuitry can include a DMA engine and/or a matrix multiplication unit (MU). At 1004, based on receipt of an instruction to perform compression of data using a codebook, at 1006, the circuitry can create a codebook and code values for the data and store the codebook into memory. For example, codebook compression of data can include utilization of vector quantization (VQ) and K-means to cluster vectors and representative code vectors of the codebook. At 1008, based on detection of one or more outlier values, an outlier code and the outlier value can be stored using a variable length code in the memory.

At 1004, based on receipt of an instruction to perform decompression of data based on a codebook, at 1010, the circuitry can decompress data using a stored codebook and store the decompressed data into a register or cache of a processor. Based on the codebook including an outlier code and outlier value, decompression of data can generate the outlier value. For example, the processor can include a core or MU.

FIG. 11 depicts a system. In some examples, circuitry of system 1100 can decompress codebook encoded values, as described herein. System 1100 includes processor 1110, which provides processing, operation management, and execution of instructions for system 1100. Processor 1110 can include any type of microprocessor, central processing unit (CPU), graphics processing unit (GPU), XPU, processing core, or other processing hardware to provide processing for system 1100, or a combination of processors. An XPU can include one or more of: a CPU, a graphics processing unit (GPU), general purpose GPU (GPGPU), and/or other processing units (e.g., accelerators or programmable or fixed function field programmable gate arrays (FPGAs)). Processor 1110 controls the overall operation of system 1100, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1100 includes interface 1112 coupled to processor 1110, which can represent a higher speed interface or a high throughput interface for system components that needs higher bandwidth connections, such as memory subsystem 1120 or graphics interface components 1140, or accelerators 1142. Interface 1112 represents an interface circuit, which can be a standalone component or integrated onto a processor die. Graphics interface 1140 can provide an interface to graphics components for providing a visual display to a user of system 1100. In one example, graphics interface 1140 can drive a display that provides an output to a user. In one example, the display can include a touchscreen display. In one example, graphics interface 1140 generates a display based on data stored in memory 1130 or based on operations executed by processor 1110 or both. In one example, graphics interface 1140 generates a display based on data stored in memory 1130 or based on operations executed by processor 1110 or both.

Accelerators 1142 can be a programmable or fixed function offload engine that can be accessed or used by a processor 1110. For example, an accelerator among accelerators 1142 can provide data compression (DC) capability, cryptography services such as public key encryption (PKE), cipher, hash/authentication capabilities, decryption, or other capabilities or services. In some cases, accelerators 1142 can be integrated into a CPU socket (e.g., a connector to a motherboard or circuit board that includes a CPU and provides an electrical interface with the CPU). For example, accelerators 1142 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1142 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, large language model (LLM), small language model (SLM), vision language model (VLM), generative AI, agentic AI, or other AI or ML model. Multiple neural networks, processor cores, or graphics processing units can be made available for use by AI or ML models to perform learning and/or inference operations.

Memory subsystem 1120 represents the main memory of system 1100 and provides storage for code to be executed by processor 1110, or data values to be used in executing a routine. Memory subsystem 1120 can include one or more memory devices 1130 such as read-only memory (ROM), flash memory, one or more varieties of random access memory (RAM) such as DRAM, or other memory devices, or a combination of such devices. Memory 1130 stores and hosts, among other things, operating system (OS) 1132 to provide a software platform for execution of instructions in system 1100. Additionally, applications 1134 can execute on the software platform of OS 1132 from memory 1130. Applications 1134 represent programs that have their own operational logic to perform execution of one or more functions. Processes 1136 represent agents or routines that provide auxiliary functions to OS 1132 or one or more applications 1134 or a combination. OS 1132, applications 1134, and processes 1136 provide software logic to provide functions for system 1100. In one example, memory subsystem 1120 includes memory controller 1122, which is a memory controller to generate and issue commands to memory 1130. It will be understood that memory controller 1122 could be a physical part of processor 1110 or a physical part of interface 1112. For example, memory controller 1122 can be an integrated memory controller, integrated onto a circuit with processor 1110.

Applications 1134 and/or processes 1136 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1132 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

A driver can advertise capability of DMA engine of processors 1110 or accelerators 1142 to compress or decompress data based on a codebook, as described herein. In some examples, a driver can enable or disable DMA engine of processors 1110 or accelerators 1142 to compress or decompress data based on a codebook, as described herein.

While not specifically illustrated, it will be understood that system 1100 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, NVLink, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1100 includes interface 1114, which can be coupled to interface 1112. In one example, interface 1114 represents an interface circuit, which can include standalone components and integrated circuitry. In one example, multiple user interface components or peripheral components, or both, couple to interface 1114. Network interface 1150 provides system 1100 the ability to communicate with remote devices (e.g., servers or other computing devices) over one or more networks. Network interface 1150 can include an Ethernet adapter, wireless interconnection components, cellular network interconnection components, USB (universal serial bus), or other wired or wireless standards-based or proprietary interfaces. Network interface 1150 can transmit data to a device that is in the same data center or rack or a remote device, which can include sending data stored in memory. Network interface 1150 can receive data from a remote device, which can include storing received data into memory. In some examples, packet processing device or network interface device 1150 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 1100 includes one or more input/output (I/O) interface(s) 1160. I/O interface 1160 can include one or more interface components through which a user interacts with system 1100. Peripheral interface 1170 can include any hardware interface not specifically mentioned above. Peripherals refer generally to devices that connect dependently to system 1100.

In one example, system 1100 includes storage subsystem 1180 to store data in a nonvolatile manner. In one example, in certain system implementations, at least certain components of storage 1180 can overlap with components of memory subsystem 1120. Storage subsystem 1180 includes storage device(s) 1184, which can be or include any conventional medium for storing large amounts of data in a nonvolatile manner, such as one or more magnetic, solid state, or optical based disks, or a combination. Storage 1184 holds code or instructions and data 1186 in a persistent state (e.g., the value is retained despite interruption of power to system 1100). Storage 1184 can be generically considered to be a “memory,” although memory 1130 is typically the executing or operating memory to provide instructions to processor 1110. Whereas storage 1184 is nonvolatile, memory 1130 can include volatile memory (e.g., the value or state of the data is indeterminate if power is interrupted to system 1100). In one example, storage subsystem 1180 includes controller 1182 to interface with storage 1184. In one example controller 1182 is a physical part of interface 1114 or processor 1110 or can include circuits or logic in both processor 1110 and interface 1114.

A volatile memory is memory whose state (and therefore the data stored in it) is indeterminate if power is interrupted to the device. A non-volatile memory (NVM) device is a memory whose state is determinate even if power is interrupted to the device.

In an example, system 1100 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1100 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more later examples, and includes a method comprising: based on a command to copy codebook compressed data from a first memory to a second memory, a direct memory access (DMA) engine copying the codebook compressed data and decompressing codebook compressed data, wherein the data comprises weight data and wherein the codebook compressed data comprises data represented by code values, and wherein the code values utilize less memory than the corresponding data; and performing matrix operations based on the decompressed codebook compressed data.

Example 2 includes one or more earlier or later examples, and includes storing the decompressed data into registers of a processor, wherein the processor comprises a core or an accelerator configured to perform matrix operations using the decompressed data.

Example 3 includes one or more earlier or later examples, wherein the performing processor-offloaded decompression of codebook compressed data comprises: based on a code value in the codebook compressed data being associated with a variable length offset, adding the offset to a value corresponding to the code value to generate decompressed data.

Example 4 includes one or more earlier or later examples, wherein the performing processor-offloaded decompression of codebook compressed data comprises: based on a first code associated with first codebook compressed data comprising a first code value and an offset, adding the offset to a value corresponding to the first code value to generate first decompressed data and based on a second code associated with codebook compressed data comprising a second code value, generating second decompressed data by determining a second value associated with the second code.

Example 5 includes one or more earlier or later examples, wherein the performing processor-offloaded decompression of codebook compressed data comprises: receiving a descriptor that specifies tensor size, stride, tensor format, and address of the codebook.

Example 6 includes one or more earlier or later examples, and includes at least one non-transitory computer-readable medium, comprising instructions stored thereon, that if executed by one or more processors, cause the one or more processors to: execute an operating system (OS) to configure a circuitry to: perform processor-offloaded decompression of codebook compressed data, wherein the data comprises weight data, wherein the codebook compressed data comprises data represented by code values, and wherein the code values utilize less memory than the corresponding data; and cause processing of the decompressed data.

Example 7 includes one or more earlier or later examples, wherein the OS is to advertise capability for the circuitry to perform offloaded decompression of codebook compressed data and to configure the circuitry to perform offloaded decompression of codebook compressed data.

Example 8 includes one or more earlier or later examples, wherein the circuitry comprises a direct memory access (DMA) engine.

Example 9 includes one or more earlier or later examples, wherein the circuitry comprises a matrix multiplication circuitry or a decoder.

Example 10 includes one or more earlier or later examples, wherein the perform processor-offloaded decompression of codebook compressed data comprises: based on a code value in the codebook compressed data being associated with a variable length offset, adding the offset to a value corresponding to the code value to generate decompressed data.

Example 11 includes one or more earlier or later examples, wherein the perform processor-offloaded decompression of codebook compressed data comprises: based on a first code associated with first codebook compressed data comprising a first code value and an offset, adding the offset to a value corresponding to the first code value to generate first decompressed data and based on a second code associated with codebook compressed data comprising a second code value, generating second decompressed data by determining a second value associated with the second code.

Example 12 includes one or more earlier or later examples, wherein the perform processor-offloaded decompression of codebook compressed data is based on a descriptor that specifies tensor size, stride, tensor format, and address of the codebook.

Example 13 includes one or more earlier or later examples, and includes an apparatus that includes: an interface and a processor, coupled to the interface, that is configured to: offload decompression of codebook compressed data to a device, wherein the data comprises weight data, wherein the codebook compressed data comprises data represented by code values, and wherein the code values utilize less memory than the corresponding data.

Example 14 includes one or more earlier or later examples, wherein the device comprises a direct memory access (DMA) engine.

Example 15 includes one or more earlier or later examples, wherein the device comprises an accelerator to perform matrix multiplication or a decoder.

Example 16 includes one or more earlier or later examples, wherein the device is to: based on a code value in the codebook compressed data being associated with a variable length offset, add the offset to a value corresponding to the code value to generate decompressed data.

Example 17 includes one or more earlier or later examples, wherein the device is to: based on a first code associated with first codebook compressed data comprising a first code value and an offset, adding the offset to a value corresponding to the first code value to generate first decompressed data and based on a second code associated with codebook compressed data comprising a second code value, generating second decompressed data by determining a second value associated with the second code.

Example 18 includes one or more earlier examples, wherein the offload decompression of codebook compressed data to the device comprises: issue a descriptor to the device, wherein the descriptor specifies tensor size, stride, tensor format, and address of the codebook.

1. A method comprising:
based on a command to copy codebook compressed data from a first memory to a second memory, a direct memory access (DMA) engine copying the codebook compressed data and decompressing codebook compressed data, wherein the data comprises weight data and wherein the codebook compressed data comprises data represented by code values, and wherein the code values utilize less memory than the corresponding data; and
performing matrix operations based on the decompressed codebook compressed data.

2. The method of claim 1, comprising:
storing the decompressed data into registers of a processor, wherein the processor comprises a core or an accelerator configured to perform matrix operations using the decompressed data.

3. The method of claim 1, wherein the performing processor-offloaded decompression of codebook compressed data comprises:
based on a code value in the codebook compressed data being associated with a variable length offset, adding the offset to a value corresponding to the code value to generate decompressed data.

4. The method of claim 1, wherein the performing processor-offloaded decompression of codebook compressed data comprises:
based on a first code associated with first codebook compressed data comprising a first code value and an offset, adding the offset to a value corresponding to the first code value to generate first decompressed data and
based on a second code associated with codebook compressed data comprising a second code value, generating second decompressed data by determining a second value associated with the second code.

5. The method of claim 1, wherein the performing processor-offloaded decompression of codebook compressed data comprises:
receiving a descriptor that specifies tensor size, stride, tensor format, and address of the codebook.

6. At least one non-transitory computer-readable medium, comprising instructions stored thereon, that if executed by one or more processors, cause the one or more processors to:
execute an operating system (OS) to configure a circuitry to:
perform processor-offloaded decompression of codebook compressed data, wherein the data comprises weight data, wherein the codebook compressed data comprises data represented by code values, and wherein the code values utilize less memory than the corresponding data; and
cause processing of the decompressed data.

7. The at least one computer-readable medium of claim 6, wherein the OS is to advertise capability for the circuitry to perform offloaded decompression of codebook compressed data and to configure the circuitry to perform offloaded decompression of codebook compressed data.

8. The at least one computer-readable medium of claim 6, wherein the circuitry comprises a direct memory access (DMA) engine.

9. The at least one computer-readable medium of claim 6, wherein the circuitry comprises a matrix multiplication circuitry or a decoder.

10. The at least one computer-readable medium of claim 6, wherein the perform processor-offloaded decompression of codebook compressed data comprises:
based on a code value in the codebook compressed data being associated with a variable length offset, adding the offset to a value corresponding to the code value to generate decompressed data.

11. The at least one computer-readable medium of claim 6, wherein the perform processor-offloaded decompression of codebook compressed data comprises:
based on a first code associated with first codebook compressed data comprising a first code value and an offset, adding the offset to a value corresponding to the first code value to generate first decompressed data and
based on a second code associated with codebook compressed data comprising a second code value, generating second decompressed data by determining a second value associated with the second code.

12. The at least one computer-readable medium of claim 6, wherein the perform processor-offloaded decompression of codebook compressed data is based on a descriptor that specifies tensor size, stride, tensor format, and address of the codebook.

13. An apparatus comprising:
an interface and
a processor, coupled to the interface, that is configured to:
offload decompression of codebook compressed data to a device, wherein the data comprises weight data, wherein the codebook compressed data comprises data represented by code values, and wherein the code values utilize less memory than the corresponding data.

14. The apparatus of claim 13, wherein the device comprises a direct memory access (DMA) engine.

15. The apparatus of claim 13, wherein the device comprises an accelerator to perform matrix multiplication or a decoder.

16. The apparatus of claim 13, wherein the device is to:
based on a code value in the codebook compressed data being associated with a variable length offset, add the offset to a value corresponding to the code value to generate decompressed data.

17. The apparatus of claim 13, wherein the device is to:
based on a first code associated with first codebook compressed data comprising a first code value and an offset, adding the offset to a value corresponding to the first code value to generate first decompressed data and
based on a second code associated with codebook compressed data comprising a second code value, generating second decompressed data by determining a second value associated with the second code.

18. The apparatus of claim 13, wherein the offload decompression of codebook compressed data to the device comprises:
issue a descriptor to the device, wherein the descriptor specifies tensor size, stride, tensor format, and address of the codebook.
